(19) United States
(12) Patent Application Publication
(10) Pub. No.: US 2019/0146969 A1
(43) Pub. Date: May 16, 2019

(54) HINT-BASED QUERIES

(71) Applicant: Hewlett-Packard Development Company, L.P., Houston, TX (US)

(72) Inventors: Jitendra KUMAR, Bangalore (IN); Raghu ANATHARANGACHAR, Bangalore (IN)

(21) Appl. No.: 16/097,378

(22) PCT Filed: Mar. 16, 2017
(86) PCT No.: PCT/US2017/022690

§ 371 Date: Oct. 29, 2018

(30) Foreign Application Priority Data
Jul. 15, 2016 (IN) IN201641024306

(51) Int. Cl. G06F 16/245; H04W 12/00; H04L 29/06; G06F 21/62; G06F 21/60; H04N 1/32; G09B 7/02

(52) U.S. Cl. CPC G06F 16/245; H04W 12/002; H04L 63/0884; G09B 7/02; G06F 21/602; H04N 1/32309; H04N 1/32267; G06F 21/6209

(57) ABSTRACT

In one example, a method is disclosed in which a user may be enabled to scan a hint associated with a query via an application in an electronic device. The hint may include unreadable data and provided at a predefined location on a medium. Further, readable data may be generated by the application from the scanned hint. The readable data may include information to assist in comprehending the query. Furthermore, the readable data may be rendered by the application on at least one of a physical medium and a display of the electronic device.

### BACKGROUND

Questions or tasks may be provided to users and in response, a performance of the users may be evaluated based on provided answers. For example, in education system, tests/exams may be conducted for student assessments. Students may receive grades based on their performance on various assessments, such as tests, quizzes, papers, and the like. In another example, in television broadcasting programs, listeners and viewers of the programs be provided with questions, and responses of the listeners and viewers be evaluated.

### BRIEF DESCRIPTION OF THE DRAWINGS

Examples are described in the following detailed description and in reference to the drawings, in which:

FIG. 1 is a block diagram of an example cloud-based environment including a portable electronic device and a cloud-based service;

FIG. 2A is a medium depicting an example query and an associated hint;

FIG. 2B illustrates an example readable data generated by scanning the hint of FIG. 2A using the portable electronic device;

FIG. 3 depicts an example cloud-based environment illustrating components of the cloud-based service to evaluate performance of a user;

FIG. 4 depicts an example flow chart to generate readable data from a scanned hint by an electronic device;

FIG. 5 depicts an example flowchart to evaluate a performance of a user via a cloud-based service based on a scanned hint;

FIG. 6 depicts an example block diagram showing a non-transitory computer-readable storage medium to generate readable data from a scanned hint; and

FIG. 7 depicts an example block diagram showing a non-transitory computer-readable storage medium to evaluate a performance of a user via a cloud-based service based on a scanned hint.

### DETAILED DESCRIPTION

In education system, when students read through a question paper/questionnaire, some of the questions set in the question paper may be unclear. While some students may exhibit a mastery, others may be deficient in answering such questions. In such cases, the students may either leave that question unattended or answer inappropriately which invariably may affect the overall score. Similarly, in some other domains (e.g., television content), the printed content may need additional interaction with subject matter expert for clarifications. In some examples, additional information in form of readable hints may be provided to clarify the question on the questionnaire. However, printing the additional information on the questionnaire may make the questionnaire to appear cumbersome. Further, when the question is clear to a user, printing the additional information may be unnecessary.

Examples described herein may provide hints (e.g., additional information) associated with a query on a medium (e.g., paper or electronic display) such that the hints may not be readable through naked eyes. In one example, the hint may be visible, but cannot be readable through unaided eyes or naked eyes. The hint may be provided at a predefined location on the medium. The predefined location may be defined by a unique identifier such as a number, a character, or a special symbol (e.g., asterisk). Example hint may include unreadable data, coded data, a watermark, text having color (e.g., white text) substantially similar to background color (e.g., color of the medium), and/or an identifier that is mapped to the readable data stored in a cloud-based service (e.g., server). For example, unreadable data may be a text line in which each text may be reversed, flipped, mirrored, rotated by an angle or a text line in significantly small font such that the hint cannot be readable through unaided eyes.

Further, users may scan the hint associated with the query via an application in an electronic device. Readable data may be generated from the scanned hint. The readable data may include information to assist the user in comprehending the query. The readable data may be displayed on a display of the electronic device and/or printed on a paper via a printer connected to the electronic device. Further, user information and hint information associated with the at least one scanned hint may be communicated to the cloud-based service to evaluate a performance of the user.

Examples described herein may enable users (e.g., students) to clarify the questions that are unclear. During examinations, question papers may be made intelligent with self-contained hints to avoid any follow-up with the teachers. Examples described herein may provide a custom application in the electronic device that makes the evaluation process simple to accommodate hint usages. Examples described herein may also be extended across other domains (e.g., television content) where queries may need additional interaction with subject matter experts for clarifications. Examples described herein may enable hybrid learning, and hence makes the entire assessment experience a very intuitive one for both students and teachers.

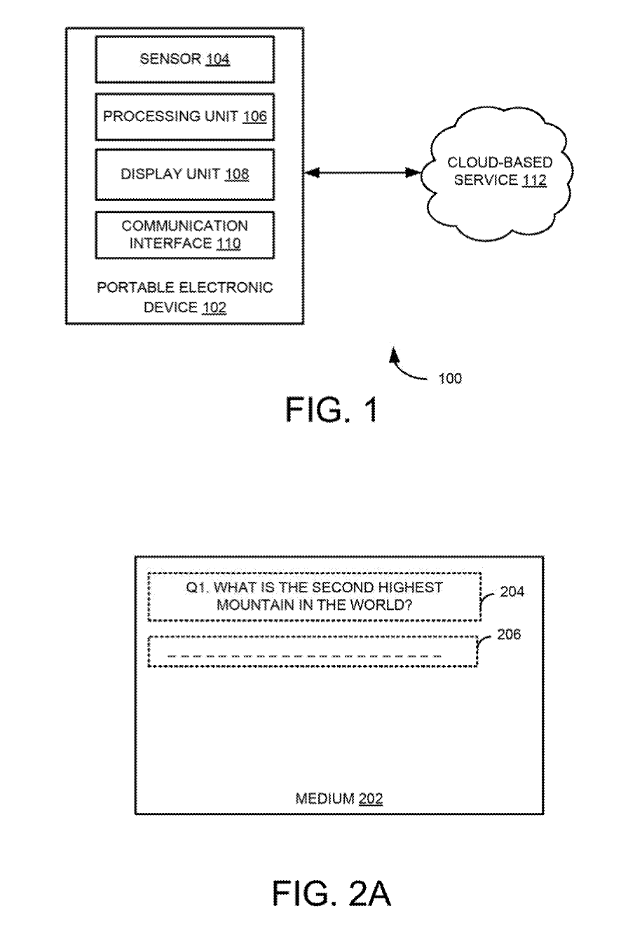

FIG. 1 is a block diagram of an example cloud-based environment 100 including a portable electronic device 102 and a cloud-based service 112. Example cloud-based environment 100 is illustrated using one portable electronic device, however, cloud-based environment 100 may include multiple portable electronic devices capable of connecting with cloud-based service 112. Example portable electronic device 102 may include, but not limited to, a cellular phone, a laptop, a desktop, a smartphone, a personal digital assistant (PDA), an Internet of Things (IoT) device and such other electronic devices capable of connecting to cloud-based service 112. Cloud-based service 112 may include arrangements of programs, infrastructure and/or platforms that may be accessible to portable electronic device 102 over a communication network (e.g., 304 as shown in FIG. 3) such as the Internet or a private network.

The hints associated with queries may be provided on a medium (e.g., paper or electronic display) such that the hints may not be readable through naked eyes. In one example, a user may scan the hints using portable electronic device 102 to generate readable data from the hints to respond to the queries.

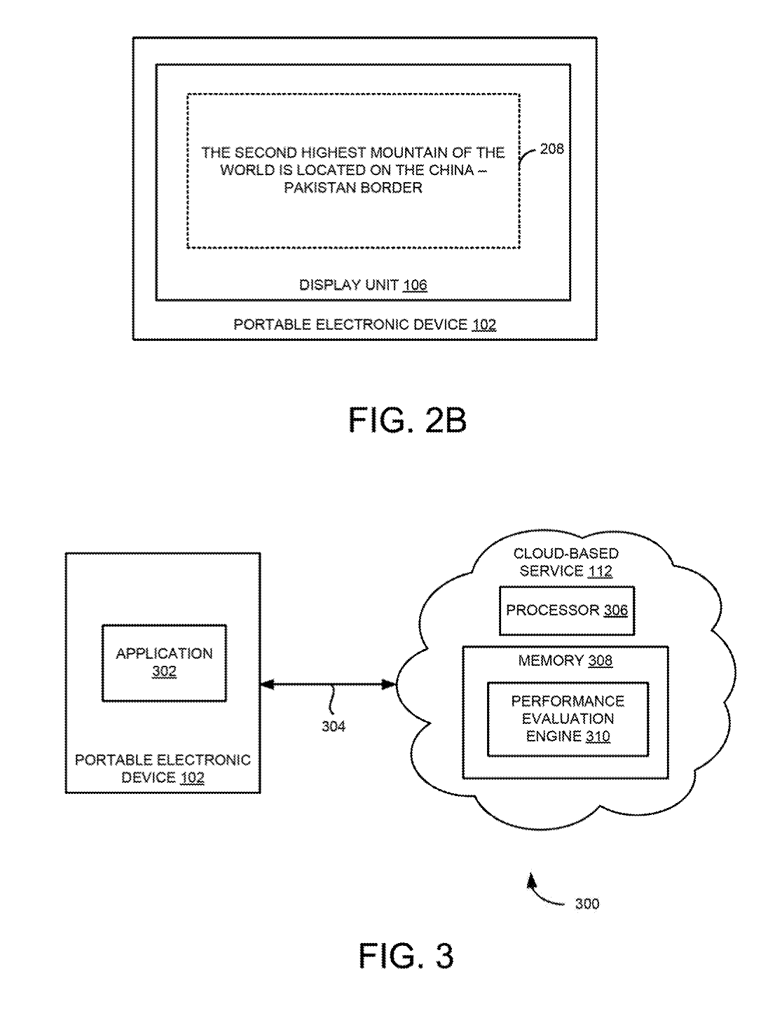

As shown in FIG. 1, portable electronic device 102 may include a sensor 104, a processing unit 106, a display unit 108, and a communication interface 110. During operation, sensor 104 may be used to scan at least one hint associated with a query upon authenticating user credentials. Example sensor 104 may include camera of electronic device 102. For example, the user credentials may include a login identifier (ID) and password. The at least one hint and the query may be provided on a medium 202 (as shown in FIG. 2A). In one example, the hints may be visible, but may not be readable through naked or unaided eyes. The hint may be provided at a predefined location on medium 202. The predefined location may be defined/identified by a unique identifier such as a number, a character, or a special symbol (e.g., asterisk). Example hint may include coded data, a watermark, text having color (e.g., white text) substantially similar to background color (e.g., color of the medium), and/or an identifier that is mapped to the readable data stored in cloud-based service 112 (e.g., server).

The term “medium” may include a physical medium or an electronic medium. Instances of the physical medium may include a paper or any other printable medium. Further, instances of the electronic medium may include a display of an electronic device such as a personal computer, mobile device, laptop, tablet, television and the like. In one example, the queries and associated hints may be provided on a paper or computer display during examination/test/quiz. In another example, the queries and associated hints may be provided on a television display during contests associated with a television program. In yet another example, the queries and associated hints may be displayed on a display screen while playing online video games.

Further, processing unit 106 may generate readable data from the scanned hint. The readable data may include additional information to assist the user in comprehending the query. For example, processing unit 106 may decrypt the scanned hint to generate the readable data when the scanned hint includes the coded data or watermark. In another example, processing unit 106 may convert the text color of the scanned hint to a color visible to the user when the scanned hint includes text having color substantially similar to background color. In yet another example, processing unit 106 may interpret and/or magnify the scanned hint to a size readable by the user when the scanned hint is not readable to the unaided eye (e.g., text line in which each text may be reversed, flipped, mirrored, rotated by an angle (e.g., 45 degrees) or a text line in significantly small font such that the hint cannot be readable through unaided eye). In yet another example, processing unit 106 may retrieve readable data from cloud-based service 112 when the scanned hint includes an identifier that is mapped to the readable data on cloud-based service 112.

Furthermore, display unit 108 may be used to display the readable data. An example hint 206 and readable data 208 are shown in FIG. 2A and FIG. 2B, respectively. FIG. 2A illustrates an example query 204 (e.g., “what is the second highest mountain in the world?”) and associated hint 206 that are provided on medium 202 (i.e., question paper). Example hint 206 may include data unreadable to the unaided eye. In this case, hint 206 may be scanned by sensor 104 of portable electronic device 102. Furthermore, processing unit 106 may generate readable data 208 by converting a text color of scanned hint 206 to a color visible. FIG. 2B illustrates example readable data 208 (e.g., “the second highest mountain of the world is located on the China-Pakistan border”) associated with scanned hint 206 as displayed on display unit 106 of portable electronic device 102.

Furthermore, communication interface 110 may communicate user information and hint information associated with the at least one hint to cloud-based service 112, which may be used to evaluate a performance of the user. For example, user information may include a unique identifier associated with the user and the hint information may include a hint identifier and a number of hints scanned by the user. In one example, the user information and hint information may be communicated to cloud-based service 112 via the communication network (e.g., 304 of FIG. 3). Evaluation of the performance is explained in detail in FIG. 3.

FIG. 3 is a block diagram of an example cloud-based environment 300 illustrating a cloud-based service 112 to evaluate the performance of the user. As shown in FIG. 3, cloud-based service 112 may include a processor 306 and a memory 308. Memory 308 may include a performance evaluation engine 310.

During operation, performance evaluation engine 310 may enable the user to access an application 302 residing in electronic device 102 upon successful authentication of user credentials. The terms “portable electronic device” and “electronic device” may be used interchangeably throughout the document. Application 302 may include functions performed by processing unit 106 and communication interface 110 as described above. Upon authenticating the user, performance evaluation engine 310 may enable the user to scan hints associated with queries via application 302 in electronic device 102. In an example, each hint may be associated with a query and may be provided at a predefined location on a medium. Furthermore, performance evaluation engine 310 may receive a user information and a hint information associated with at least one hint when the at least one hint is scanned via application 302 residing in electronic device 102. In an example, the user information may include a unique identifier associated with the user such as a user identity number, an examination roll number, a candidate serial number, mobile number and the like. The user information may enable cloud-based service 112 to identify the user. Further, the hint information may include a hint identifier associated with the at least one scanned hint and a number of scanned hints. In an example, the hint identifier may include information that enables cloud-based service 112 to identify the hints used by the user.

Furthermore, performance evaluation engine 310 may evaluate the performance of the user based on a number of hints scanned by the user using the user information and the hint information. In an example, a hint usage by the user may result in a reduction of a score or a reward of the user by a predefined value. For example, the user information and the hint information may be used by performance evaluation engine 310 to downgrade a percentage of a score or reward to the user depending on the number of hints used by the user, for instance, to reply to the query. For example, as shown in FIG. 2B, performance evaluation engine 310 may reduce a predefined percentage of a score (e.g., 10% out of total marks associated with the query) of the user when the user accesses hint 206 associated with query 204.

In one example, the components of portable electronic device 102 and cloud-based service 112 may be implemented in hardware, machine-readable instructions or a combination thereof. In one example, each of processing unit 106 and communication interface 110 of portable electronic device 102 and performance evaluation engine 310 of cloud-based service 112 may be implemented as engines or modules comprising any combination of hardware and programming to implement the functionalities described herein. Even though FIG. 1 describes about portable electronic device 102, the functionality of the components of portable electronic device 102 may be implemented in other electronic devices such as desktop computers, tablet computers, smartphone, mobile devices and the like.

Portable electronic device 102 and cloud-based service 112 may include computer-readable storage medium comprising (e.g. encoded with) instructions executable by a processor to implement functionalities described herein in relation to FIG. 1. In some examples the functionalities described herein, in relation to instructions to implement functions of components of portable electronic device 102 and cloud-based service 112 and any additional instructions described herein in relation to the storage medium, may be interpreted as engines or modules comprising any combination of hardware and programming to implement the functionalities of the modules or engines described herein. The functions of components of portable electronic device 102 and cloud-based service 112 may also be implemented by the processor. In examples described herein, the processor may include, for example, one processor or multiple processors included in a single device or distributed across multiple devices.

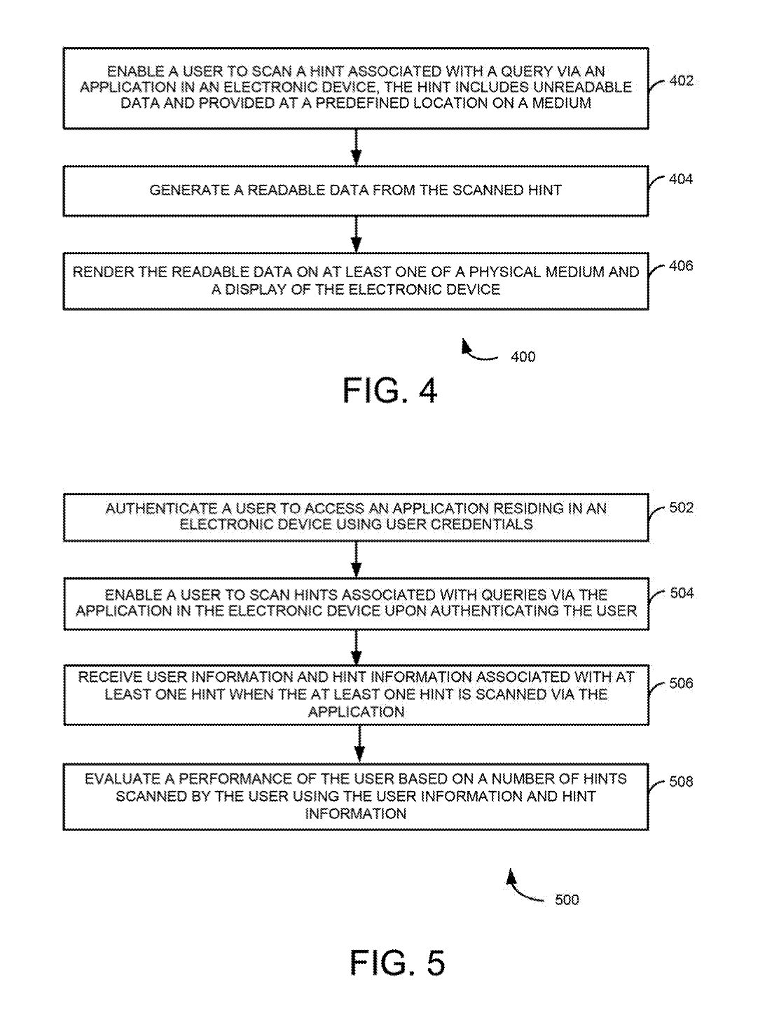

FIGS. 4 and 5 depict example flow charts to generate readable data from a scanned hint, and evaluate a performance of a user based on the scanned hint, respectively. The hint may include visible data that can be unreadable through naked or unaided eyes or an invisible hint such as text color substantially similar to background color or watermark. It should be understood the processes depicted in FIGS. 4 and 5 represent generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flowcharts illustrate functional information to design or fabricate circuits, generate machine-readable instructions, or use a combination of hardware and machine-readable instructions to perform the illustrated processes.

FIG. 4 depicts an example flow chart 400 to, generate readable, data from a scanned hint. The hint may include unreadable data, coded data such as a matrix, a barcode, a QR (quick response) code, an encrypted data, and the like, a watermark, a text color substantially similar to a background color, or an identifier mapped to the readable data on a cloud-based service. At 402, a user may be enabled to scan the hint using an application (e.g., computer program) running on an electronic device. The hint may be associated to a query presented to the user. Furthermore, the hint and the query may be provided at a predefined location on an electronic medium or a physical medium. The predefined location may be defined by a unique identifier such as a number, a character, or a special symbol (e.g., asterisk). In an example, the user may be provided access to the application upon authentication of user credentials by the cloud-based service. In this example, prior to scanning the hint, the user may be enabled/prompted to input the user credentials to login into the application via the electronic device. The user credentials may be communicated to the cloud-based service. Further, the cloud-based service may authenticate the user using the user credentials, and enable the user to access the application upon successful authentication.

At 404, the readable data may be generated via the application from the scanned hint. The readable data may include information that can assist the user in comprehending the query. In an example, the readable data may be generated by decoding the scanned hint when the scanned hint includes coded data or watermark. In another example, the readable data may be generated by converting a color of the scanned hint to a color visible to the user when the scanned hint includes data invisible to an unaided eye. In yet another example, the readable data may be generated by interpreting and/or magnifying the scanned hint when the scanned hint may not be readable to an unaided eye (e.g., text line in which each text may be reversed, flipped, mirrored, rotated by an angle or a text line in significantly small font such that the hint cannot be readable through unaided eye). In yet another example, the readable data may be retrieved from the cloud-based service when the scanned hint includes an identifier that may be mapped to the readable data on the cloud-based service. At 406, the readable data may be rendered on a physical medium or a display of the electronic device. In an example, the readable data may be printed on the physical medium such as a paper by a printer connected to the electronic device. For example, the application in the electronic device may allow the questions with readable data to be printed when the hints are scanned.

Further, user information and hint information associated with the scanned hint may be communicated by the application to the cloud-based service. The user information and the hint information may be communicated via a communication network such as an Internet. In an example, the user information and the hint information may be communicated to the cloud-based service upon rendering the readable data. Example user information may include a unique identifier associated with the user to identify the user corresponding to the scanned hint, and the hint information may include a hint identifier associated with the scanned hint to identify the scanned hint and a number of hints used by the user. A performance of the user may be evaluated by the cloud-based service using the user information and the hint information. For example, during examination, the application residing in the electronic device may communicate to the cloud-based service about student's usage of the hints and a scoring system may reduce student's marks corresponding to each used hint. Example method of evaluating the performance of the user by the cloud-based service is explained in detail in FIG. 5.

FIG. 5 depicts an example flow chart 500 to evaluate a performance of a user via the cloud-based service based on a scanned hint. At 502, a user may be authenticated by the cloud-based service to access an application running in an electronic device. In an example, user credentials such as login identifier (ID) and password inputted by the user may be used to authenticate the user. At 504, upon authentication, the user may be enabled to scan hints associated with queries via the application. For example, each hint may be associated with a query and may be provided at a predefined location on a physical medium or an electronic medium. At 506, the cloud-based service may receive user information and hint information associated with at least one hint when the at least one hint is scanned via the application. At 508, the performance of the user may be evaluated by the cloud-based service based on a number of hints scanned by the user using the user information and the hint information. In an example, the hint information may include a hint identifier associated with the at least one scanned hint and a number of scanned hints, and the user information may include a unique identifier associated with the user. Further, the user information and the hint information may be used to downgrade a percentage of score or reward to the user based on the number of hints scanned by the user.

In one example, during examination/quiz/test, a student may refer to a hint to take help to answer a question. The mobile application may communicate student's usage of the hint to cloud-based service. During evaluation, performance evaluation engine (e.g., a scoring system) may reduce the marks for each hint used based on the information stored in the cloud-based service. Example process is explained below:

1) Student may attempt to answer questions in a questionaire during an examination.

2) Student may need help to answer some questions in the questionaire.

3) Student may start a mobile application (e.g., hint-mobile-app) running on an electronic device such as a smart phone.

4) Mobile application may read the hint written in the hint section.

5) Mobile application may generate readable data, for instance, by magnifying the hint, and provide the readable data of the hint for the question.

6) Student may answer the question based on the readable data. If needed, student may have the option to use additional hints associated with the questions.

7) The mobile application may upload the hints used by the student to a central repository (e.g., cloud-based service). The student may be identified based on the login information associated with the mobile application.

8) During marks computation, a percentage of marks (e.g., 10% for each used hint) may be deducted for the identified student for using hints for various questions. In one example, the percentage of marks may be deducted for each question depending on a number of hints accessed/used for each question. For example, 10% of marks associated with a question may be deducted when the student uses one hint for answering the question and 15% of marks associated with the question may be deducted when the student uses two hints for answering the question.

In another example, during a television contest, a viewer may need a hint to answer a question associated with a contest. Example process is explained below:

1) The viewer may attempt to answer the question displayed on a television screen. The question may be related to a program that is being viewed by the viewer.

2) The viewer may need help to answer the question.

3) Viewer may login to a mobile application (e.g., hint-mobile-app) in an electronic device such as a smart phone.

4) Mobile application may enable to scan the hint provided in the hint section.

5) Mobile application may generate readable data based on the scanned hint.

6) The viewer may answer the question based on the readable data associated with the hint. For example, the viewer may use multiple hints associated with the question, if needed.

7) The mobile application may communicate the hint used by the viewer to a program service provider.

8) The service provider may reduce a prize amount to the viewer for using the hint. In one example, the service provider may reduce a prize amount to the viewer depending on a number of hints accessed/used to answer the question.

Similarly, a user may use hints associated with an online gaming contest while playing online games. The processes 400 and 500 of FIGS. 4 and 5 may show example processes and it should be understood that other configurations can be employed to practice the techniques of the present application. For example, processes 400 and 500 may communicate with a plurality of electronic devices and a cloud-based service.

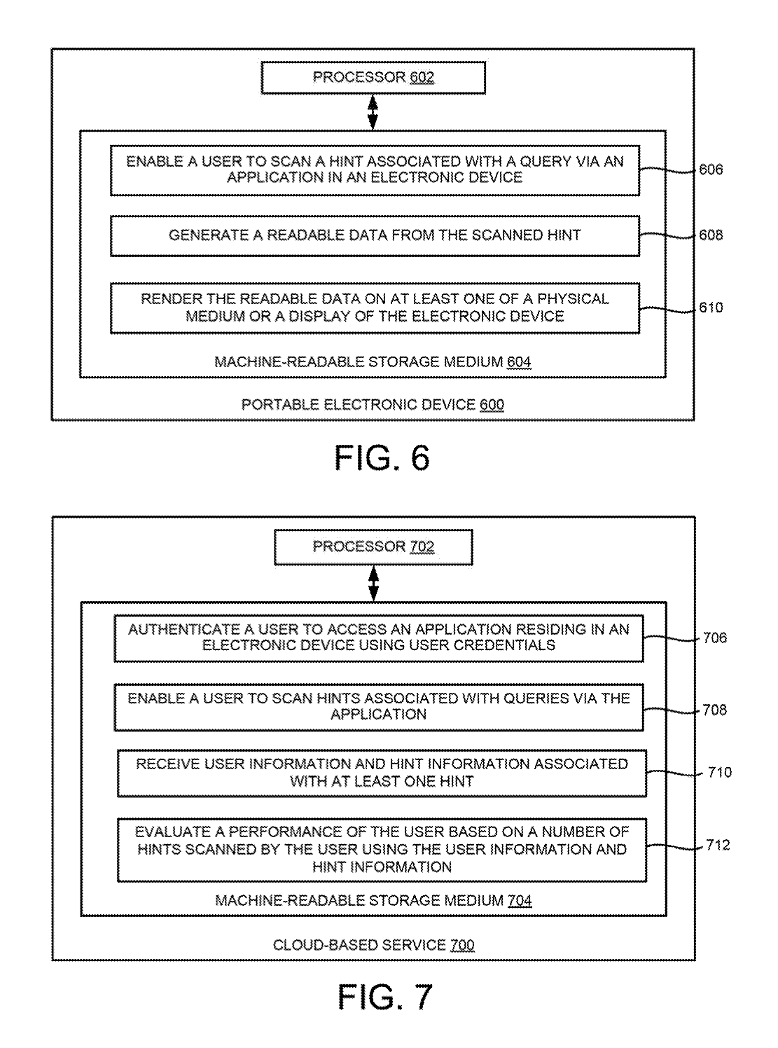

FIGS. 6 and 7 are example block diagrams 600 and 700 showing non-transitory computer-readable media that stores code for operation in accordance with an example of the techniques of the present application. Particularly, FIG. 6 illustrates electronic device side implementation (e.g., 600) of the process to generate readable data from a scanned hint. FIG. 7 illustrates cloud-based service side implementation (e.g., 700) of the process to evaluate performance of a user based on user information associated with a scanned hint. Non-transitory computer-readable media includes a machine-readable storage medium 604 on electronic device 600 and machine-readable storage medium 704 on cloud-based service device 700. Non-transitory computer-readable media may be generally referred by the reference numbers 604 and 704 and may be included in a computing system such as electronic device 600 and/or cloud-based service 700, respectively. Non-transitory computer-readable media 604 and 704 may correspond to any storage device that stores computer-implemented instructions, such as programming code and the like. For example, non-transitory computer-readable media 604 and 704 may include non-volatile memory, volatile memory, and/or storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

Processors 602 and 702 generally retrieve and execute the instructions stored in non-transitory computer-readable media 604 and 704, respectively, to operate the present techniques in accordance with an example. In one example, the tangible, computer-readable media 604 and 704 can be accessed by the respective one of processors 602 and 702 over a bus.

Machine-readable storage medium 604 may store instructions 606-610. In an example, instructions 606-610 may be executed by processor 602 to provide a mechanism for electronic device side implementation of the process as described in FIG. 4.

Machine-readable storage media 704 may store instructions 706-712. In an example, instructions 706-712 may be executed by processor 702 to provide a mechanism for cloud-based service side implementation of the process to evaluate the performance of the user as described in FIG. 6.

As used herein, a “processor” may include processor resources such as at least one of a Central Processing Unit (CPU), a semiconductor-based microprocessor, a Graphics Processing Unit (GPU), a Field-Programmable Gate Array (FPGA) to retrieve and execute instructions, other electronic circuitry suitable for the retrieval and execution instructions stored on a computer-readable medium, or a combination thereof. The processor fetches, decodes, and executes instructions stored on computer-readable medium to perform the functionalities described below. In other examples, the functionalities of any of the instructions of computer-readable media 604 and 704 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media may be part of an article article of manufacture). An article or article of manufacture may refer to any manufactured single component or multiple components. The medium may be located either in the system executing the computer-readable instructions, or remote from but accessible to the system (e.g., via a computer network) for execution. In the example of FIGS. 6 and 7, each of computer-readable media 604 and 704 may be implemented by one computer-readable medium, or multiple computer-readable media.

In examples described herein, devices, such as computing devices and printing devices, may communicate with each other via a network interface device. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (.g., a cellular telephone network).

In some examples, instructions may be part of an installation package that, when installed, may be executed by processors 602 and 702 to implement the functionalities described herein in relation to instructions, In such examples, computer-readable media 604 and 704 may be a portable medium, such as a CD, DVD, or flash drive, or a memory maintained by a server from which the installation package can be downloaded and installed. In other examples, instructions may be part of an application, applications, or component(s) already installed on electronic device 600 and cloud-based service 700 including processors 602 and 702, respectively. In such examples, computer-readable media 604 and 704 may include memory such as a hard drive, solid state drive, or the like.

It may be noted that the above-described examples of the present solution may be for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the procedures of any method or process so disclosed, may be combined in any combination, except combinations where at least some of such features and/or procedures are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that may be described as based on some stimulus can be based on the stimulus or a combination of stimuli including the stimulus.

The present description has been shown end described with reference to the foregoing examples. It may be understood, however, that other forms, details, and examples can be made without departing from the spirit and scope of the present subject matter that is defined in the following claims.

What is claimed is:

1. A portable electronic device comprising:
a sensor to scan at least one hint associated with a query upon authenticating user credentials of a user;
a processing unit to generate readable data from the scanned hint;
a display unit to display the readable data; and
a communication interface to communicate user information and hint information associated with the at least one hint to a cloud-based service, wherein the user information and the hint information are used to evaluate a performance of the user.

2. The portable electronic device of claim 1, wherein the at least one hint comprises one of unreadable data, coded data, a watermark, text color substantially similar to background color, and an identifier mapped to the readable data stored in the cloud-based service.

3. The portable electronic device of claim 1, wherein the unreadable data comprises a text line in which each text may be reversed, flipped, mirrored, or rotated by an angle, or a text line in significantly small font such that the hint is not readable through unaided eye.

4. The portable electronic device of claim 1, wherein the processing unit to generate the readable data from the scanned hint by one of:
decrypting the scanned hint;
converting a color of the scanned hint to a visible color;
interpreting and/or magnifying the scanned hint; and
retrieving the readable data from the cloud-based service when the scanned hint is mapped to the readable data on the cloud-based service.

5. The portable electronic device of claim 1, wherein the query and the hint are provided on one of a physical medium or electronic medium.

6. The portable electronic device of claim 1, wherein the communication interface to communicate the user information and the hint information associated with the at least one hint to the cloud-based service via a communication network, wherein the user information comprises a unique identifier associated with the user, and wherein the hint information comprises a hint identifier and a number of scanned hints.

7. A method comprising:
enabling a user to scan a hint associated with a query via an application in an electronic device, wherein the hint comprises unreadable data and provided at a predefined location on a medium;
generating, by the application, readable data from the scanned hint, wherein the readable data comprises information to assist in comprehending the query; and
rendering, by the application, the readable data on at least one of a physical medium and a display of the electronic device.

8. The method of claim 7, wherein rendering the readable data on the physical medium comprises:
printing the readable data on the physical medium via a printer connected to the electronic device, wherein the physical medium comprises a paper.

9. The method of claim 7, further comprising;
prior to scanning the hint:
enabling the user to input user credentials;
communicating the user credentials to a cloud-based service, wherein the cloud-based service is to authenticate the user based on the user credentials; and
enabling the user to access the application upon successful authentication.

10. The method of claim 7, further comprising:
communicating, by the application, user information and hint information associated with the scanned hint via a communication network to a cloud-based service upon rendering the readable data, wherein the user information includes a unique identifier associated with the user, and wherein the hint information comprises a hint identifier associated with the scanned hint; and
evaluating, via the cloud-based service, a performance of the user using the user information and the hint information.

11. The method of claim 7, wherein the hint comprises one of unreadable data, coded data, a watermark, text having color substantially similar to background color, and an identifier mapped to the readable data stored in a cloud-based service.

12. The method of claim 7, wherein the readable data is generated by at least one of:
decoding the scanned hint to obtain the readable data when the scanned hint comprises coded data or watermark;
converting a color of the scanned hint to a color visible to the user when the scanned hint comprises data to an unaided eye:
interpreting and/or magnifying the scanned hint when the scanned hint comprises data not readable to the unaided eye; and
retrieving the readable data from a cloud-based service when the scanned hint includes an identifier that is mapped to the readable data on the cloud-based service.

13. A cloud-based service comprising:
a processor;
a memory, wherein the memory includes a performance evaluation engine to:
authenticate a user to access an application residing ire an electronic device using user credentials;
enable a user to scan hints associated with queries via the application in the electronic device upon authenticating the user, wherein each hint is associated with a query and provided at a predefined location on a medium;
receive user information and hint information associated with at least one hint when the at least one hint is scanned via the application residing in the electronic device; and
evaluate a performance of the user based on a number of hints scanned by the user using the user information and the hint information.

14. The cloud-based service of claim 13, wherein the hint comprises one of unreadable data, coded data, a watermark, text having color substantially similar to background color, and an identifier mapped to the readable data stored in the cloud-based service, wherein the user information includes a unique identifier associated with the user, and wherein the hint information comprises a hint identifier associated with the at least one scanned hint and a number of scanned hints.

15. The cloud-based service of claim 13, wherein the performance evaluation engine is to evaluate the performance of the user by:
downgrading a percentage of score or reward to the user based on the number of hints scanned by the user using the user information and the hint information.
